(19) United States
(12) Patent Application Publication
(10) Pub. No.: US 2010/0269356 A1
(43) Pub. Date: Oct. 28, 2010

(54) Gardening Shears Allowing Entrance of a User's Finger to Facilitate the User Holding the Gardening Shears

(76) Inventor: Chi-Tung Chen, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/430,306

(22) Filed: Apr. 27, 2009

(51) Int. Cl. B26B 13/00; B26B 13/28

(52) U.S. Cl. 30/232; 30/261

(57) ABSTRACT

A pair of gardening shears include a first pivot base having a first blade and a first handle, a second pivot base pivotally connected with the first pivot base and having a second blade and a connecting portion, a mounting base having a second handle connected with the connecting portion to drive the second pivot base relative to the first pivot base, and a plug having an insert which extends through the mounting base, the first pivot base and the second pivot base and has an inner portion provided with a finger hole. Thus, when a user is operating the first handle and the second handle, the finger hole of the plug allows passage of the user's finger, so that the user can hold the first handle and the second handle stably to operate the shears smoothly.

### BACKGROUND OF THE INVENTION

1. Field of the Invention

The present invention relates to shears and, more particularly, to a pair of gardening shears for shearing branches, leaves and the like.

2. Description of the Related Art

A pair of conventional gardening shears in accordance with the prior art shown in FIG. 6 comprise a first pivot base 45 having a first side provided with a first blade 41 and a second side provided with a first handle 40, a second pivot base 55 pivotally connected with the first pivot base 45 by a pivot volt 42 and having a first side provided with a second blade 51 and a second side provided with a second handle 50, and an elastic member 52 biased between the first handle 40 of the first pivot base 45 and the second handle 50 of the second pivot base 55. Thus, when the first handle 50 and the second handle 40 are compressed by an external force to move toward each other, the first blade 41 and the second blade 51 are moved toward each other to perform a cutting action. However, when a user's hand holds the first handle 50 and the second handle 40 to operate the first blade 41 and the second blade 51, the user's hand easily slips from the first handle 50 and the second handle 40 due to a larger force so that the shears easily fall down. In addition, when the shears are not in use temporarily, the shears cannot be hung on the branches or a protrusion, so that the user needs to find a plane to place the shears, thereby greatly causing inconvenience to the user.

### BRIEF SUMMARY OF THE INVENTION

In accordance with the present invention, there is provided a pair of gardening shears, comprising a first pivot base having a first side provided with a first blade and a second side provided with a first handle, a second pivot base pivotally connected with the first pivot base and having a first side provided with a second blade and a second side provided with a connecting portion, a mounting base mounted on the first pivot base and the second pivot base and having a side provided with a second handle connected with the connecting portion of the second pivot base to drive the second pivot base to pivot relative to the first pivot base, and a plug secured on the mounting base and provided with an insert which extends through the mounting base, the first pivot base and the second pivot base and has an inner portion provided with a finger hole.

The primary objective of the present invention is to provide a pair of gardening shears that allow entrance of a user's finger to facilitate the user holding the gardening shears.

Another objective of the present invention is to provide a pair of gardening shears, wherein when a user is operating the first handle and the second handle, the finger hole of the plug allows passage of the user's finger, so that the user can hold the first handle and the second handle stably to operate the shears smoothly.

A further objective of the present invention is to provide a pair of gardening shears, wherein when operation of the shears is stopped temporarily, the finger hole of the plug can be hung on a protrusion, such as a hanger, branch and the like, thereby facilitating the user operating the shears.

A further objective of the present invention is to provide a pair of gardening shears, wherein the elastic member is fully hidden in the mounting hole of the mounting base so that the elastic member will not be exposed outwardly to prevent the elastic member from being worn out.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pair of gardening shears in accordance with the preferred embodiment of the present invention.

FIG. 2 is a partially exploded perspective view of the gardening shears as shown in FIG. 1.

FIG. 3 is an exploded perspective assembly view of the gardening shears as shown in FIG. 1.

FIG. 4 is a cross-sectional view of the gardening shears as shown in FIG. 1.

FIG. 5 is a schematic side operational view of the gardening shears as shown in FIG. 1 in use.

FIG. 6 is a perspective view of a pair of conventional gardening shears in accordance with the prior art.

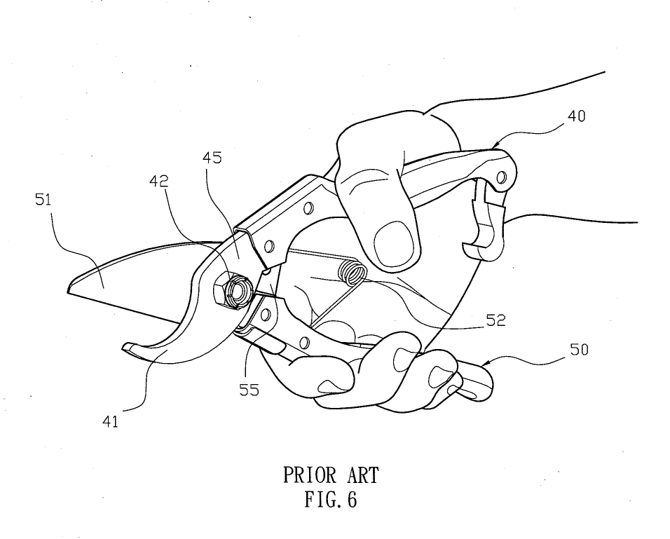

### DETAILED DESCRIPTION OF THE INVENTION

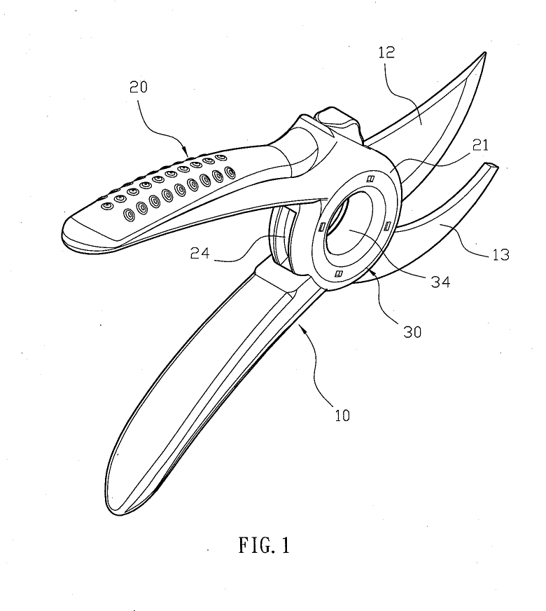

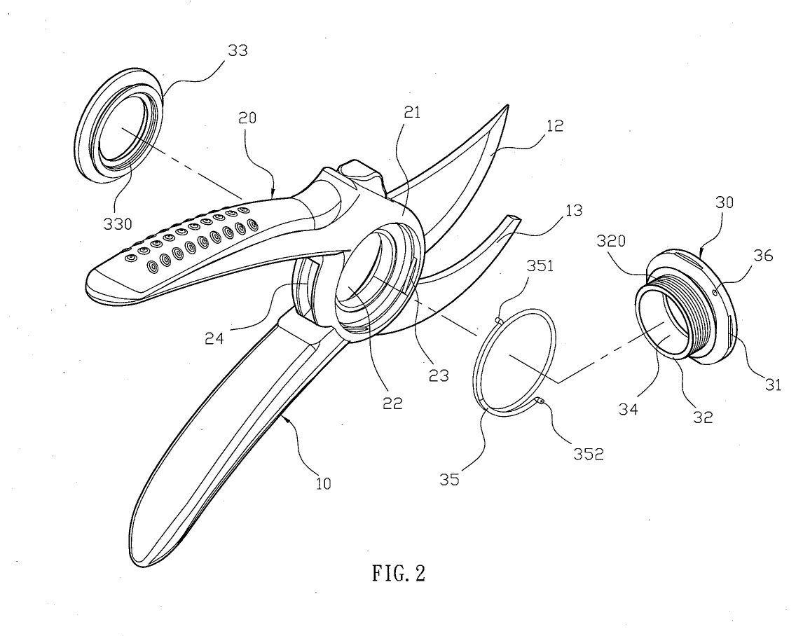

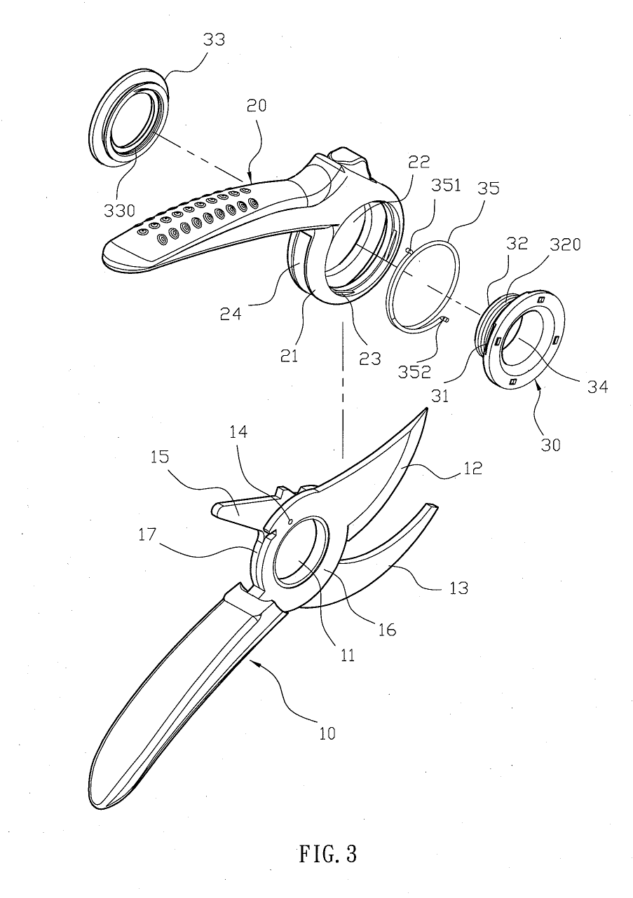

Referring to the drawings and initially to FIGS. 1-4, a pair of gardening shears in accordance with the preferred embodiment of the present invention comprise a first pivot base 16 having a first side provided with a first blade 12 and a second side provided with a first handle 10, a second pivot base 17 pivotally connected with the first pivot base 16 and having a first side provided with a second blade 13 and a second side provided with a connecting portion 15, a mounting base 21 mounted on the first pivot base 16 and the second pivot base 17 and having a side provided with a second handle 20 connected with the connecting portion 15 of the second pivot base 17 to drive the second pivot base 17 to pivot relative to the first pivot base 16, a plug 30 secured on the mounting base 21 and provided with an insert 32 which extends through the mounting base 21, the first pivot base 16 and the second pivot base 17 and has an inner portion provided with a finger hole 34 to allow passage of a user's finger, an end cap 33 mounted on the mounting base 21 and combined with the insert 32 of the plug 30, and an elastic member 35 biased between the plug 30 and the first pivot base 16.

The first pivot base 16 has an inner portion provided with a shaft hole 11 to allow passage of the insert 32 of the plug 30. The first pivot base 16 has a periphery provided with a fixing hole 14.

The mounting base 21 has an inner portion provided with a mounting hole 22 to allow passage of the insert 32 of the plug 30. The mounting hole 22 of the mounting base 21 is connected to and co-axial with the shaft hole 11 of the first pivot base 16. The mounting hole 22 of the mounting base 21 is drive by the second handle 20 to pivot about the first pivot base 16. The mounting hole 22 of the mounting base 21 has a wall provided with a plurality of positioning blocks 23. The mounting base 21 has a peripheral wall provided with an elongate receiving channel 24 mounted on the first pivot base 16 and the second pivot base 17. The receiving channel 24 of the mounting base 21 is connected to the mounting hole 22 of the mounting base 21 to allow passage of the connecting portion 15 of the second pivot base 17.

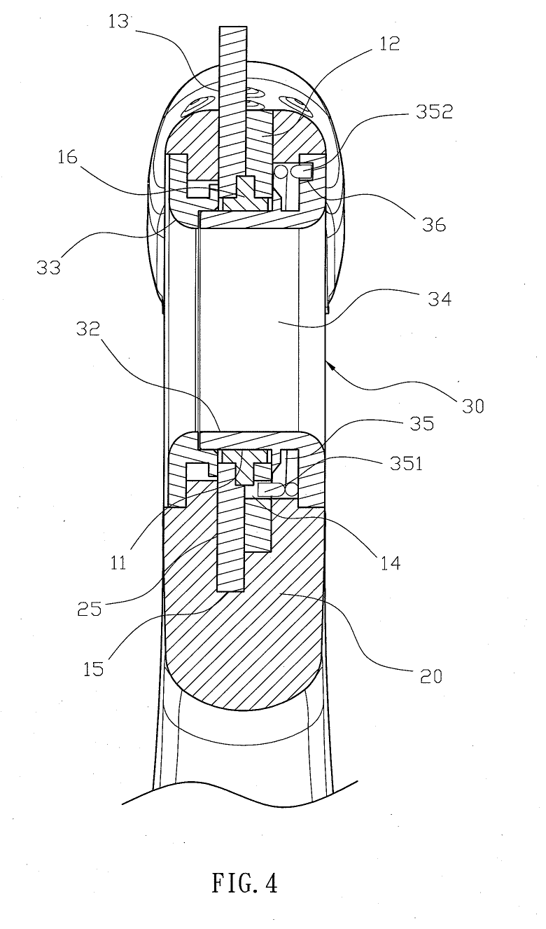

The second handle 20 has an inner portion provided with a fixing slot 25 (see FIG. 4) secured on the connecting portion 15 of the second pivot base 17 so that the connecting portion 15 of the second pivot base 17 is combined with and driven by the second handle 20.

The plug 30 abuts a first side of the mounting base 21. The plug 30 has a peripheral wall provided with a plurality of positioning grooves 31 secured on the positioning blocks 23 of the mounting base 21 so that the plug 30 is fixed on the mounting base 21 to pivot in concert with the mounting base 21. Thus, the plug 30 is non-rotatable relative to the mounting base 21. The plug 30 has a side provided with a fixing bore 36. The insert 32 of the plug 30 in turn extends through the mounting hole 22 of the mounting base 21 and the shaft hole 11 of the first pivot base 16 to connect the mounting base 21 and the first pivot base 16. The insert 32 of the plug 30 has an outer wall provided with an outer thread 320. The finger hole 34 of the insert 32 extends through a whole length of the plug 30.

The end cap 33 abuts a second side of the mounting base 21. The end cap 33 has an inner wall provided with an inner thread 330 screwed onto the outer thread 320 of the insert 32 so that the end cap 33 is combined with the plug 30 to locate the mounting base 21, the first pivot base 16 and the second pivot base 17 between the plug 30 and the end cap 33.

The elastic member 35 is mounted on the insert 32 of the plug 30 and encompassed by the mounting base 21 so that the elastic member 35 is fully hidden in the mounting hole 22 of the mounting base 21. The elastic member 35 is a torsion spring and has a first end 351 secured in the fixing hole 14 of the first pivot base 16 and a second end 352 secured in the fixing bore 36 of the plug 30. Thus, the first pivot base 16 is driven by the first end 351 of the elastic member 35 to drive the first blade 12, while the plug 30 is driven by the second end 352 of the elastic member 35 to drive the mounting base 21 which drives the second handle 20 which drives the connecting portion 15 which drives the second pivot base 17 which drives the second blade 13, so that the first blade 12 and the second blade 13 are moved outwardly to space from each other by the elastic force of the elastic member 35. Thus, the first blade 12 and the second blade 13 are opened at a normal state.

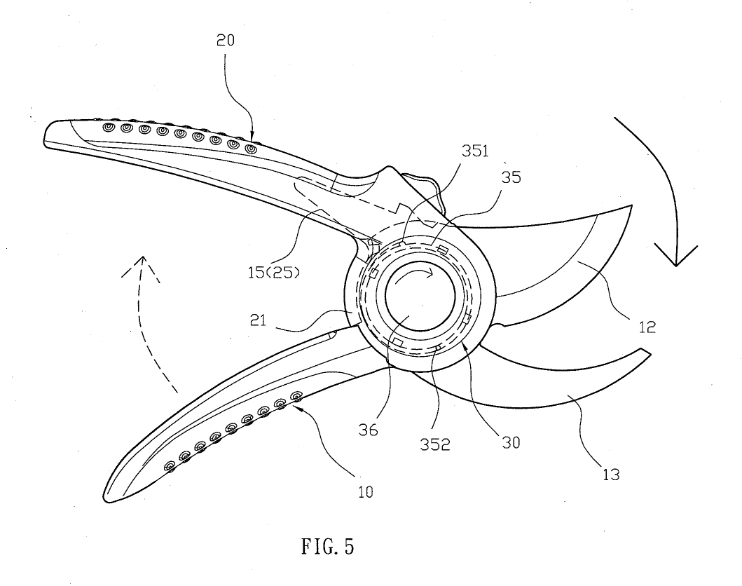

In operation, referring to FIG. 5 with reference to FIGS. 1-4, when the second handle 20 and the first handle 10 are compressed by an external force to move toward each other, the connecting portion 15 is driven by the second handle 20 to drive the second pivot base 17 to pivot about the first pivot base 16, so that the second blade 13 and the first blade 12 are pivoted and moved toward each other to perform a cutting action.

Accordingly, when a user is operating the first handle 10 and the second handle 20, the finger hole 34 of the plug 30 allows passage of the user's finger, so that the user can hold the first handle 10 and the second handle 20 stably to operate the shears smoothly. In addition, when operation of the shears is stopped temporarily, the finger hole 34 of the plug 30 can be hung on a protrusion, such as a hanger, branch and the like, thereby facilitating the user operating the shears. Further, the elastic member 35 is fully hidden in the mounting hole 22 of the mounting base 21 so that the elastic member 35 will not be exposed outwardly to prevent the elastic member 35 from being worn out.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pair of gardening shears, comprising:
a first pivot base having a first side provided with a first blade and a second side provided with a first handle;
a second pivot base pivotally connected with the first pivot base and having a first side provided with a second blade and a second side provided with a connecting portion;
a mounting base mounted on the first pivot base and the second pivot base and having a side provided with a second handle connected with the connecting portion of the second pivot base to drive the second pivot base to pivot relative to the first pivot base;
a plug secured on the mounting base and provided with an insert which extends through the mounting base, the first pivot base and the second pivot base and has an inner portion provided with a finger hole.

2. The gardening shears of claim 1, wherein the first pivot base has an inner portion provided with a shaft hole to allow passage of the insert of the plug.

3. The gardening shears of claim 2, wherein the mounting base has an inner portion provided with a mounting hole to allow passage of the insert of the plug.

4. The gardening shears of claim 3, wherein the mounting hole of the mounting base is connected to and co-axial with the shaft hole of the first pivot base.

5. The gardening shears of claim 3, wherein the mounting base has a peripheral wall provided with an elongate receiving channel mounted on the first pivot base and the second pivot base.

6. The gardening shears of claim 3, wherein
the plug is fixed on the mounting base to pivot in concert with the mounting base;
the plug is non-rotatable relative to the mounting base;
the mounting hole of the mounting base has a wall provided with a plurality of positioning blocks;
the plug has a peripheral wall provided with a plurality of positioning grooves secured on the positioning blocks of the mounting base.

7. The gardening shears of claim 1, further comprising:
an end cap mounted on the mounting base and combined with the insert of the plug.

8. The gardening shears of claim 1, further comprising:
an elastic member biased between the plug and the first pivot base.

9. The gardening shears of claim 7, wherein
the plug abuts a first side of the mounting base;
the end cap abuts a second side of the mounting base.

10. The gardening shears of claim 9, wherein the end cap is combined with the plug to locate the mounting base, the first pivot base and the second pivot base between the plug and the end cap.

11. The gardening shears of claim 10, wherein
the insert of the plug has an outer wall provided with an outer thread;
the end cap has an inner wall provided with an inner thread screwed onto the outer thread of the insert.

12. The gardening shears of claim 8, wherein
the first pivot base has a periphery provided with a fixing hole;
the plug has a side provided with a fixing bore;
the elastic member has a first end secured in the fixing hole of the first pivot base and a second end secured in the fixing bore of the plug.

13. The gardening shears of claim 12, wherein the elastic member is a torsion spring.

14. The gardening shears of claim 8, wherein the elastic member is mounted on the insert of the plug.

15. The gardening shears of claim 8, wherein
the elastic member is encompassed by the mounting base;
the elastic member is fully hidden in the mounting hole of the mounting base.

16. The gardening shears of claim 5, wherein the receiving channel of the mounting base is connected to the mounting hole of the mounting base to allow passage of the connecting portion of the second pivot base.

17. The gardening shears of claim 3, wherein the insert of the plug in turn extends through the mounting hole of the mounting base and the shaft hole of the first pivot base to connect the mounting base and the first pivot base.

18. The gardening shears of claim 1, wherein the finger hole of the insert extends through a whole length of the plug.

19. The gardening shears of claim 3, wherein the mounting hole of the mounting base is drive by the second handle to pivot about the first pivot base.

20. The gardening shears of claim 1, wherein
the second handle has an inner portion provided with a fixing slot secured on the connecting portion of the second pivot base;
the connecting portion of the second pivot base is combined with and driven by the second handle.
